(19) United States
(12) Patent Application Publication
(10) Pub. No.: US 2016/0263845 A1
(43) Pub. Date: Sep. 15, 2016

(54) METHOD FOR REPAIRING SANDWICH PANELS MADE OF COMPOSITE MATERIALS INVOLVING THE CREATION OF A CORE OR OF A MOULD USING STEREOLITHOGRAPHY

(71) Applicant: AIRCELLE, GONFREVILLE L'ORCHER (FR)

(72) Inventors: Arnaud DELEHOUZE, SAINNEVILLE SUR SEINE (FR); Jean-Philippe MUCHERIE, LE HAVRE (FR)

(73) Assignee: AIRCELLE, GONFREVILLE L'ORCHER (FR)

(21) Appl. No.: 15/164,913

(22) Filed: May 26, 2016

Related U.S. Application Data
(63) Continuation of application No. PCT/FR2014/052994, filed on Nov. 21, 2014.

(30) Foreign Application Priority Data
Nov. 28, 2013 (FR) 13/61761

(51) Int. Cl. B29C 73/04; B29C 73/06; F01D 25/24; B64D 27/16; B64D 29/08; B29C 67/00; B28B 1/00

(52) U.S. Cl. CPC B29C 73/04; B29C 67/0066; B29C 73/06; B28B 1/001; B64D 27/16; B64D 29/08; F01D 25/24; B33Y 10/00

(57) ABSTRACT

A method for repairing sandwich panels made of composite materials following impact that has damaged the core of the panel is provided. The method involves acquisition of a numerical model of the shape of the damaged zone then use of a stereolithography method based on the numerical model to create a replacement core or a mould in which this replacement core will be moulded, followed by creation of replacement component comprising this core, then the instillation of this component which is fitted into an opening cut in the sandwich panel around the damage, and finally attachment of the replacement component to the panel.

### CROSS-REFERENCE TO RELATED APPLICATIONS

This application is a continuation of International Application No. PCT/FR2014/052994, filed on Nov. 21, 2014, which claims the benefit of FR 13/61761, filed on Nov. 28, 2013. The disclosures of the above applications are incorporated herein by reference.

### FIELD

The present disclosure relates to a method for repairing sandwich panels of composite materials, as well as a sandwich panel and a turbojet engine nacelle repaired with such a method.

### BACKGROUND

The statements in this section merely provide background information related to the present disclosure and may not constitute prior art.

Sandwich panels of composite materials, have a central core covered by two outer skins, constitute a reduced mass assembly including high rigidity.

It is possible to make panels of any shape which are increasingly used, in particular in the field of aeronautics. This type of panel is, in particular used in nacelles containing a turbojet engine, in order to make rigid structures including good aerodynamic profiling.

The making of these panels generally includes the manufacture of a core which may be a rigid foam, or a structure having transverse honeycomb-shaped cavities, of plastic material or aluminum alloy, in particular, which is draped in fibers impregnated with resin forming folds constituting a skin, or face sheet, on each side.

This assembly is then pressed in a mould, then baked in an oven (sometimes cured in an autoclave) in order to polymerize the resin. Panels are produced which may take any shape, including a particular size which may be fitted by defining the thickness of the core, as well as the nature and the number of face sheets locally disposed on each side.

In case of a significant shock on this type of sandwich panel, used in particular in the field of aeronautics, causing a damage to the core, in particular a through perforation of the panel, the whole panel is then usually replaced.

However, these replacements may require lead time of new parts, which must then be manufactured if no part is available in stock. Furthermore, the cost of a new part may be relatively expensive, the ecological/environmental impact of a discarded entire part is of concern, and the complete changing of the part may create a negative image to customers.

### SUMMARY

In one form, the present disclosure provides a method for repairing sandwich panels of composite materials including a core receiving a skin on each side, after an object having damaged the core or a skin of this panel, noteworthy in that it includes the acquisition of a digital model of the damaged area shape, then using a stereolithography (or other 3D printing technique) method from the digital model, a core and/or a replacement skin, or a mould in which this replacement core will be moulded and/or a mould in which this replacement skin will be moulded, on which a core will be bonded, then the making of a replacement part comprising this core and/or this skin, then the setting up of this part which is fitted within an opening cut in the sandwich panel around the damage, and finally the fastening of the replacement part/patch on the panel.

An advantage of this repair method is that from a digital model of the shape received from the manufacturer of the panel, or directly acquired by measurements on the damaged panel, it is possible to simply and quickly make by the stereolithography method, without lead time of particular parts, a mould or a core exactly corresponding to the shape of the damaged area. This mould or this core then allows producing the replacement part comprising the original shapes, which will economically replace only the damaged area of the panel.

The repair method according to the present disclosure may further include one or more of the following characteristics, which may be combined.

According to one form, stereolithography is employed to make a mould or a core and/or a replacement skin from a polymerization of resins under the effect of light and heat.

According to another form, stereolithography is employed to make a mould or a core and/or a metallic or ceramic skin, from mixtures of powders with a paste composed of photosensitive resin.

In particular, the repair method may make a core and/or a porous metallic skin. This core and/or this skin may advantageously include characteristics similar to those of the core and/or the original skin.

Advantageously, the method according to the present disclosure may make a porous metallic replacement core.

Advantageously, the repair method makes the replacement part by covering the replacement core with first layers of folds which are draped thereon, the set of folds constituting at least one portion of at least one of the two skins of the sandwich panel to be repaired. Thus, this core may be reinforced in order to prepare the replacement part.

The layers of folds may be draped directly on the mould.

The replacement part is fastened by mechanical splicing on the panel to be repaired, that is to say that it is fastened by means of at least one metallic or composite joining part fastened on the replacement part and on the sandwich panel to be repaired by fasteners passing straight through the sandwich panel or not.

Advantageously, the repair method makes the fastening of the replacement part in the opening of the panel, by the removal of covering folds on both sides of the panel. Thus, continuity of the two skins of the panel, which gives it its rigidity, is obtained.

The present disclosure also relates to a sandwich panel of composite materials including a core receiving a skin on each side, this panel having received a replacement part fitted into an opening in order to perform a repair, with a repair method comprising any one of the preceding characteristics.

The present disclosure further relates to a turbojet engine nacelle provided for an aircraft, comprising sandwich panels of composite materials including a core receiving a skin on each side, this panel having received a replacement part fitted into an opening in order to perform a repair, with a repair method comprising any one of the preceding characteristics.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows one method of manufacturing a composite panel according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It is, in particular, possible to make panels comprising shells forming outer or inner surfaces of aircraft nacelles, which have smooth shapes that provide aerodynamic efficiency.

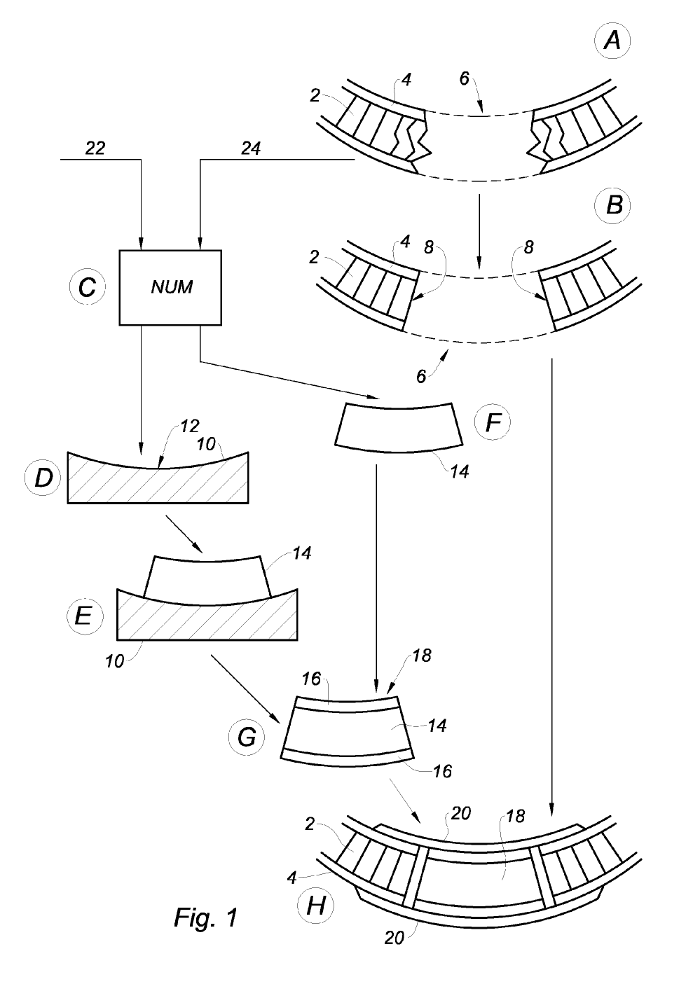

Referring to FIG. 1, step A, a panel has received a break in its curvature, forming a damaged area including an opening 6 completely passing therethrough.

In a second step B, a cutting through the entire thickness of the panel is made around the damaged area as shown, in order to maintain the undamaged or non-deformed portion of the panel, in order to form the opening 6 comprising a simple-shaped contour, having edges perpendicular to the surface 8 which are clear/smooth and prepared for further steps.

A next step C, which may be performed in parallel, includes the making of a digital file which may be the recovery 22 of digital models/geometry of the original manufacturer of the panel, such as a CAD (computer aided design) model, or the reconstitution 24 of digital data from physical measurements performed directly on the damaged panel, for example by a coordinate measurement machine (CMM).

According to a first form, a next step D includes the making of a mould 10 from the digital file, made by a stereolithography method in one form, which includes a smooth inner surface 12 having a curvature corresponding to that of the panel in its damaged portion.

A next step E includes the making of a core 14 and/or a repair skin in the mould 10, from materials and according to known moulding methods, covering a surface at least equal to the opening 6 of the panel which is to be replaced; the repair skin 4 is intended to be bonded to a core (2, 14).

According to a second form, alternatively to these last two steps D, E, there is directly made, in another step F, a core 14 and/or a skin 4 also obtained by the stereolithography method, and comprising in the same manner, a curvature corresponding to that of the panel in its damaged portion.

The stereolithography is a technique also called rapid prototyping, which allows manufacturing solid objects from a digital model, by making a lay-up of material thin wafers. It should be understood that other 3D printing methods may be employed while remaining within the scope of the present disclosure, and thus the use of stereolithography is merely exemplary and should not be construed as limiting the scope of the present disclosure.

In stereolithography, the three-dimensional digital model is cut into thin wafers of constant thickness, comprising a two-dimensional contour. This thickness selected by the operator determines the resolution of the process, and then the accuracy of the object which will be produced.

There are several stereolithography methods.

The oldest method is the photo-polymerization, relying on the properties of some resins to be polymerized under the effect of light and heat. The used resin is generally a mixture of acrylate or epoxy monomers, and a photoinitiator which initiates the polymerization of the material under the effect of light.

In this method, a movable platform immersed in a liquid resin tank, supports the model during manufacture. A fixed laser or light source includes a control device of the beam, and another orientation of this beam allowing directing it at any point of the platform.

The wafers constituting the model are then treated one by one. The laser beam scans the liquid resin surface depending on the shape of the wafer defined by a software, in order to solidify a wafer by making a solid polymer. The platform then descends from a height corresponding to the thickness of the wafer according to the selected resolution, and the process is repeated in order to form a new wafer completely secured to the preceding one.

After rinsing the model obtained in order to remove the non-polymerized resin, the final step includes a baking of the object in order to harden it.

A method, more recently developed, allows producing metallic or ceramic parts, by mixing corresponding powders in a paste composed of photosensitive resin.

The mixture, once irradiated by the laser radiation, forms a polymer network trapping the mineral particles. At the end, a heat treatment of the object allows obtaining a dense ceramic.

It is thus possible, with the latter method, to make directly in step F, a core 14 of metallic or ceramic materials, which may be porous or not, precisely reproducing the original portion of the core of the panel which has been removed.

After one of the two embodiments of the core 14, a next step G includes the preparation of a replacement part 18 comprising this core, which is covered, if required, by first layers of folds 16 which are draped thereon and are subjected to a first baking, in order to give this part some resistance.

If required, the cutting of the contour of the replacement part 18 is retouched in order to ensure its fitting into the opening 6 of the panel.

The final step H includes the fitting of the replacement part 18 in the opening 6 of the panel, then the fastening of this part by a known connection means, comprising, for example the connection of covering folds 20 on both sides of the panel in order to obtain increased strength of the assembly.

Thus, there is obtained a repaired panel which has regained the integrity of its inner core and/or its outer skin(s) 4, and which may include characteristics similar to those of the original panel, in particular concerning the mechanical, aerodynamic and acoustic properties.

In particular for the panels subjected to different types of specific stresses, such as panels of a turbojet engine nacelle for which the mass and the aerodynamic as well as the acoustic performances given by particular shapes, which must be respected, are important, this type of quick and economical repair is particularly suitable.

What is claimed is:

1. A method for repairing a sandwich panel including a core receiving a skin on each side of the core, the method comprising:
acquisition of a digital model of a damaged area of the sandwich panel;
making by a 3D printing method, from the digital model, a replacement core and/or a replacement skin, or a mould in which the replacement core will be moulded and/or a mould in which the replacement skin will be moulded;
making a replacement part comprising the replacement core and/or the replacement skin;
fitting the replacement part into an opening in the sandwich panel proximate the damaged area; and
fastening the replacement part onto the sandwich panel.

2. The method according to claim 1, wherein the 3D printing method is stereolithography.

3. The method according to claim 1, wherein the 3D printing method makes a mould or a core and/or a replacement skin from a polymerization of resins under the effect of light and heat.

4. The method according to claim 1, wherein the 3D printing method makes a mould or a core and/or a metallic or ceramic skin, from mixtures of powders with a paste composed of photosensitive resin.

5. The method according to claim 4, wherein the 3D printing method makes a porous metallic replacement core.

6. The method according to claim 1, wherein the 3D printing method makes the replacement part by covering the replacement core by the first layers of folds which are draped thereon, the set of folds constituting at least one portion of at least one of the two skins of the sandwich panel to be repaired.

7. The method according to claim 5, wherein the layers of folds are draped directly on the mould of the replacement core.

8. The method according to claim 1, wherein the replacement part is fastened by mechanical splicing on the sandwich panel to be repaired.

9. The method according to claim 1, wherein the method makes the fastening of the replacement part in the opening of the sandwich panel by removal of covering folds on both sides of the panel.

10. A sandwich panel made of composite materials including a core receiving a skin on each side, the panel having received a replacement part fitted into an opening in order to perform a repair, wherein the replacement part is made according to claim 1.

11. A turbojet nacelle provided for an aircraft, comprising sandwich panels of composite materials including a core receiving a skin on each side, the panel having received a replacement part fitted into an opening in order to perform a repair, wherein the replacement part is made according to claim 1.
